(19) United States
(12) Patent Application Publication
(10) Pub. No.: US 2022/0203973 A1
(43) Pub. Date: Jun. 30, 2022

(54) METHODS AND SYSTEMS FOR GENERATING NAVIGATION INFORMATION IN A REGION

(71) Applicant: HERE Global B.V., Eindhoven (NL)

(72) Inventors: Nick DRONEN, Chicago, IL (US); Brad KESERICH, Chicago, IL (US); Steve O'HARA, Chicago, IL (US); Andrew ADARE, Chicago, IL (US); Vlad SHESTAK, Chicago, IL (US); Josh FINKEN, Chicago, IL (US)

(21) Appl. No.: 17/137,023

(22) Filed: Dec. 29, 2020

(51) Int. Cl. B60W 30/095; G06K 9/00; G06N 20/00; B60W 50/14

(52) U.S. Cl. CPC B60W 30/0956; G06K 9/00805; B60W 2554/404; B60W 50/14; B60W 2050/143; G06N 20/00

(57) ABSTRACT

A method, a system, and a computer program product are provided for generating navigation information in a region. The method comprises obtaining sensor data and vehicle communication data associated with a vehicle, and generating a local map associated with the surrounding of the vehicle based on the sensor data and the vehicle communication data. The sensor data comprises a first information associated with one or more vehicles in vicinity of the vehicle. The first information may be obtained using a first machine learning model. The method also includes transmitting the local map associated with the surrounding of the vehicle to a mapping platform and, processing the local map, by using a second machine learning model stored in the mapping platform, and generating the navigation information in the region, based on the output data associated with processing of the local map associated with the surrounding of the vehicle.

### TECHNOLOGICAL FIELD OF THE INVENTION

The present disclosure generally relates to routing and navigation systems, and more particularly relates to a system, a method, and a computer program product for generating navigation information in a region.

### BACKGROUND

Various navigation applications are available to aid a user, for example by providing directions for driving, walking, or other modes of travel. Web-based and mobile app-based systems offer navigation applications that allow a user to request directions from one point to another. Often times, there are risky situations encountered on road while driving of a vehicle that may be caused by multiple reasons like construction on the roads, poor signal timings, traffic incidents, and the like. These situations on road may create situations such as personal injury, fatality, risk like situations for other vehicles and pedestrians as well. These situations sometimes also lead to vehicle crashes with the consequences of huge economic impact because of lack of quick road safety assistance or lack of safety warning signal of such event for the vehicle driving upstream to react. Therefore, it is essential to assess such risky situations on the road and to safely navigate while driving.

### BRIEF SUMMARY

Oftentimes, the risky situations on the road are caused by presence of one or more surrounding vehicles, in vicinity of an ego vehicle, which may tend to demonstrate risky behavior related to driving safety. An ego vehicle, for the purposes of various embodiments described herein, may be a vehicle being considered for all observations and calculations in a particular scenario. The ego vehicle may be a manually driven vehicle, an autonomous vehicle or a semi-autonomous vehicle. For example, when the ego vehicle is driving in vicinity of a truck carrying heavy loads, it may be advisable to travel at a safe distance threshold from the truck, to avoid situations such as accidental dropping of a heavy load item from the truck, which could lead to a serious traffic incident. These situations may be avoided if the ego vehicle is equipped with good quality situational, spatial and contextual awareness data about the vehicles on the road, and more specifically in vicinity of the ego vehicle, to avoid serious traffic incidents, like crashes or accidents. The requirement of such data may be more pronounced in case of autonomous vehicles, which need to navigate through complex driving scenarios, while ensuring safety of the passengers and emulating human driver responses.

Accordingly, there is a need to generate situational awareness for vehicles on a road and notify about the situation to vehicles. A method, a system, and a computer program product are provided in accordance with an example embodiment described herein for generating navigation information in a region.

Embodiments of the disclosure provide a method for generating navigation information in a region. The method comprises obtaining sensor data and vehicle communication data associated with a vehicle. The method comprises generating based on the sensor data and the vehicle communication data, a local map associated with the surrounding of the vehicle wherein the sensor data comprises a first information associated with one or more vehicles in vicinity of the vehicle, and wherein the first information is determined based on a first machine learning model. The method comprises transmitting the local map associated with the surrounding of the vehicle to a mapping platform. The method further comprises processing, by a second machine learning model stored in the mapping platform, the local map associated with the surrounding of the vehicle, to provide an output data. The method further comprises generating the navigation information in the region, based on the output data associated with processing of the local map associated with the surrounding of the vehicle.

According to some example embodiments, the sensor data comprises data associated with one or more of the one or more vehicles in vicinity of the vehicle on a road, a surrounding of the vehicle, one or more intersections, and a plurality of road objects.

According to some example embodiments, the first information comprises information associated with at least one of a make information for each vehicle in the one or more vehicles, a model information for each vehicle in the one or more vehicles, or a combination thereof.

According to some example embodiments, the vehicle communication data comprises at least one of: speed data, acceleration data, and heading data; associated with at least one of the one or more vehicles in vicinity of the vehicle, and one or more road objects in vicinity of the vehicle.

According to some example embodiments, generating the navigation information in the region comprises generating information associated with situational awareness, and contextual awareness in the surrounding of the vehicle.

According to some example embodiments, providing the output data further comprises providing an alert notification to a user of the vehicle for providing navigation information in the region.

According to some example embodiments, the method further comprises characterizing the vehicle based on the output data, wherein the characterizing comprises associating the vehicle with one or more predefined categories of vehicles, wherein the one or more predefined categories comprise at least one of a high risk vehicle, a low risk vehicle, a medium risk vehicle, or a combination thereof.

Embodiments of the disclosure provide a system for generating navigation information in a region. The system comprises a memory configured to store computer executable instructions and one or more processors configured to execute the instructions to obtain sensor data and vehicle communication data associated with a vehicle. The one or more processors are further configured to generate, based on the sensor data and the vehicle communication data, a local map associated with the surrounding of the vehicle, wherein the sensor data comprises a first information associated with one or more vehicles in vicinity of the vehicle, and wherein the first information is determined based on a first machine learning model. The one or more processors are further configured to transmit the local map associated with the surrounding of the vehicle to a mapping platform. The one or more processors are further configured to process, by a second machine learning model stored in the mapping platform, the local map associated with the surrounding of the vehicle, to provide an output data. The one or more processors are further configured to generate the navigation information in the region, based on the output data associated with processing of the local map associated with the surrounding of the vehicle.

Embodiments of the disclosure provide a computer programmable product for generating navigational information in a region. The computer programmable product comprises a non-transitory computer readable medium having stored thereon computer executable instruction which when executed by one or more processors, cause the one or more processors to carry out operations for characterizing one or more vehicles. The operations comprising obtaining sensor data associated with the one or more vehicles, wherein the one or more vehicles are in vicinity of an ego vehicle. The operations comprising determining, based on a first machine learning model, first information associated with each of the one or more vehicles in vicinity of the ego vehicle. The operations further comprising obtaining vehicle communication data associated with the one or more vehicles and generating based on the first information associated with each of the one or more vehicles and the vehicle communication data, a local map associated with a surrounding of the ego vehicle. The local map comprises: a spatial distribution of the one or more vehicles in the surrounding of the ego vehicle; and an indication of the first information associated with each of the one or more vehicles. The operations comprising transmitting the map local associated with the surrounding of the ego vehicle to a mapping platform. The operations further comprising processing, using a second machine learning model stored in the mapping platform, the local map associated with the surrounding of the ego vehicle. The operations further comprising characterizing, based on the processing of the local map by the second machine learning model, each of the one or more vehicles to output a navigation information for the ego vehicle.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

Having thus described example embodiments of the invention in general terms, reference will now be made to the accompanying drawings, which are not necessarily drawn to scale, and wherein:

FIG. 1 illustrates a schematic diagram of a network environment of a system for generating navigation information, in accordance with an example embodiment;

FIG. 2 illustrates a block diagram of the system, exemplarily illustrated in FIG. 1, for generating navigation information, in accordance with an example embodiment;

FIG. 3 illustrates a block diagram of a map database used to store data, such as sensor data for generating navigational information in accordance with an embodiment;

FIG. 4A illustrates an exemplary block diagram of a scenario for generating a local map of surroundings of a vehicle, in accordance with an example embodiment, in accordance with an example embodiment;

FIG. 4B illustrates an exemplary front camera view of the vehicle for generating the local map of surroundings of the vehicle, in accordance with an example embodiment;

FIG. 5 illustrates a block diagram of another exemplary scenario of on-road vehicles for generating navigation information, in accordance with an example embodiment;

FIG. 6 illustrates a block diagram of a system for generating navigation information, in accordance with an example embodiment;

FIG. 7 illustrates a block diagram of another system for generating navigation information, in accordance with an example embodiment; and

FIG. 8 illustrates a flow diagram of a method for generating navigation information, in accordance with an example embodiment.

### DETAILED DESCRIPTION

In the following description, for purposes of explanation, numerous specific details are set forth in order to provide a thorough understanding of the present disclosure. It will be apparent, however, to one skilled in the art that the present disclosure can be practiced without these specific details. In other instances, systems, apparatuses and methods are shown in block diagram form only in order to avoid obscuring the present disclosure.

Reference in this specification to “one embodiment” or “an embodiment” means that a particular feature, structure, or characteristic described in connection with the embodiment is included in at least one embodiment of the present disclosure. The appearance of the phrase “in one embodiment” in various places in the specification are not necessarily all referring to the same embodiment, nor are separate or alternative embodiments mutually exclusive of other embodiments. Further, the terms “a” and “an” herein do not denote a limitation of quantity, but rather denote the presence of at least one of the referenced items. Moreover, various features are described which may be exhibited by some embodiments and not by others. Similarly, various requirements are described which may be requirements for some embodiments but not for other embodiments.

Some embodiments of the present invention will now be described more fully hereinafter with reference to the accompanying drawings, in which some, but not all, embodiments of the invention are shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information,” and similar terms may be used interchangeably to refer to data capable of being transmitted, received and/or stored in accordance with embodiments of the present invention. Thus, use of any such terms should not be taken to limit the spirit and scope of embodiments of the present invention.

Additionally, as used herein, the term ‘circuitry’ may refer to (a) hardware-only circuit implementations (for example, implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device, and/or other computing device.

As defined herein, a “computer-readable storage medium,” which refers to a non-transitory physical storage medium (for example, volatile or non-volatile memory device), can be differentiated from a “computer-readable transmission medium,” which refers to an electromagnetic signal.

The embodiments are described herein for illustrative purposes and are subject to many variations. It is understood that various omissions and substitutions of equivalents are contemplated as circumstances may suggest or render expedient but are intended to cover the application or implementation without departing from the spirit or the scope of the present disclosure. Further, it is to be understood that the phraseology and terminology employed herein are for the purpose of the description and should not be regarded as limiting. Any heading utilized within this description is for convenience only and has no legal or limiting effect.

### Definitions

The term “link” may be used to refer to any connecting pathway including but not limited to a roadway, a highway, a freeway, an expressway, a lane, a street path, a road, an alley, a controlled access roadway, a free access roadway and the like.

The term “route” may be used to refer to a path from a source location to a destination location on any link.

The term “vicinity” may be used to refer an area or a region within a threshold distance from a point of observation. For example, if the point of observation is the ego vehicle, then “vicinity” of the ego vehicle may be determined by a circular region bounded by a radius equal to the threshold distance. The threshold distance may be a configurable value which is adjusted and varies from application to application.

The term “autonomous vehicle” may refer to any vehicle having autonomous driving capabilities at least in some conditions. An autonomous vehicle, as used throughout this disclosure, may refer to a vehicle having autonomous driving capabilities at least in some conditions. The autonomous vehicle may also be known as a driverless car, robot car, self-driving car or autonomous car. For example, the vehicle may have zero passengers or passengers that do not manually drive the vehicle, but the vehicle drives and maneuvers automatically. There can also be semi-autonomous vehicles.

### End of Definitions

Embodiments of the present disclosure may provide a system, a method and a computer program product for generating navigation information in a region. The systems and methods disclosed herein provide for improved situational, spatial and contextual awareness of a vehicle travelling on road, about its surroundings. This in turn may lead to better, accurate, and safer decision making about navigation processes, which is very crucial for autonomous driving scenarios. Also, there is a need to generate informational awareness for a vehicle. Therefore, there is a need to obtain sensor data and vehicle communication data to process and generate situational awareness based on this data. There is a need to generate alerts for vehicles in case of dangerous situation so that the user or the autonomous vehicle itself, may take right decision to avoid such situations. Sometimes, the autonomous vehicles may also face dangerous situations on the road, and it may become difficult for them to take decision of reacting in such situations. Therefore, there is need to generate navigation information for such dangerous situations. These and other technical improvements of the invention will become evident from the description provided herein.

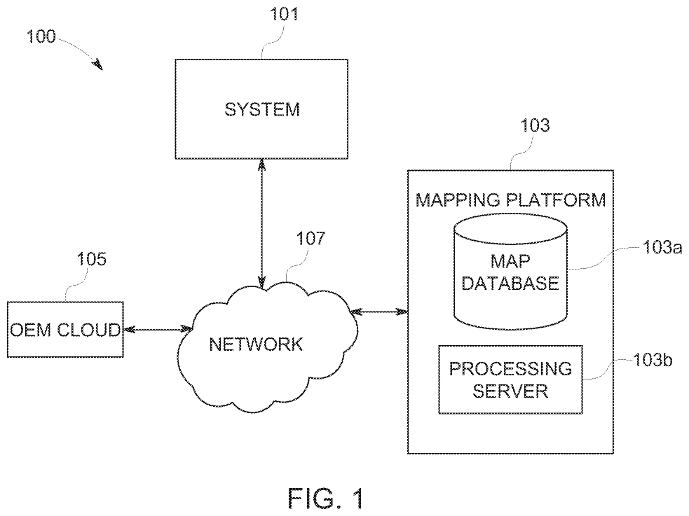

The system, the method, and the computer program product facilitating generating navigational information in a region are described with reference to FIG. 1 to FIG. 8.

FIG. 1 illustrates a schematic diagram of a network environment 100 of a system 101 for generating navigational information in a region, in accordance with an example embodiment. The system 101 may be communicatively coupled to a mapping platform 103 and an OEM (Original Equipment Manufacturer) cloud 105 connected via a network 107. The components described in the network environment 100 may be further broken down into more than one component such as one or more sensors or application in user equipment and/or combined together in any suitable arrangement. Further, it is possible that one or more components may be rearranged, changed, added, and/or removed.

In an example embodiment, the system 101 may be embodied in one or more of several ways as per the required implementation. For example, the system 101 may be embodied as a cloud based service or a cloud based platform. As such, the system 101 may be configured to operate outside a user equipment. However, in some example embodiments, the system 101 may be embodied within the user equipment, for example as a part of an in-vehicle navigation system. In each of such embodiments, the system 101 may be communicatively coupled to the components shown in FIG. 1 to carry out the desired operations and wherever required modifications may be possible within the scope of the present disclosure. In various embodiments, the system 101 may be a backend server, a remotely located server, a cloud server or the like. In an embodiment, the system 101 may be the processing server 103b of the mapping platform 103 and therefore may be co-located with or within the mapping platform 103. The system 101 may be implemented in a vehicle, where the vehicle may be an autonomous vehicle, a semi-autonomous vehicle, or a manually driven vehicle. Further, in one embodiment, the system 101 may be a standalone unit configured for generating navigational information in a region. Alternatively, the system 101 may be coupled with an external device such as the autonomous vehicle.

The mapping platform 103 may comprise a map database 103a for storing map data and a processing server 103b for carrying out processing instructions. The map database 103a may store node data, road segment data, link data, point of interest (POI) data, link identification information, heading value records, or the like. Also, the map database 103a further includes speed limit data of each lane, cartographic data, routing data, and/or maneuvering data. Additionally, the map database 103a may be updated dynamically to cumulate real time traffic conditions. The real time traffic conditions may be collected by analyzing the location transmitted to the mapping platform 103 by a large number of road users through the respective user devices of the road users. In one example, by calculating the speed of the road users along a length of road, the mapping platform 103 may generate a live traffic map, which is stored in the map database 103a in the form of real time traffic conditions. In one embodiment, the map database 103a may further store historical traffic data that includes travel times, average speeds and probe counts on each road or area at any given time of the day and any day of the year. In an embodiment, the map database 103a may store the probe data over a period of time for a vehicle to be at a link or road at a specific time. The probe data may be collected by one or more devices in the vehicle such as one or more sensors or image capturing devices or mobile devices. In an embodiment, the probe data may also be captured from a fleet of vehicles including connected-car sensors, smartphones, personal navigation devices, fixed road sensors, smart-enabled commercial vehicles, and expert monitors observing accidents and construction.

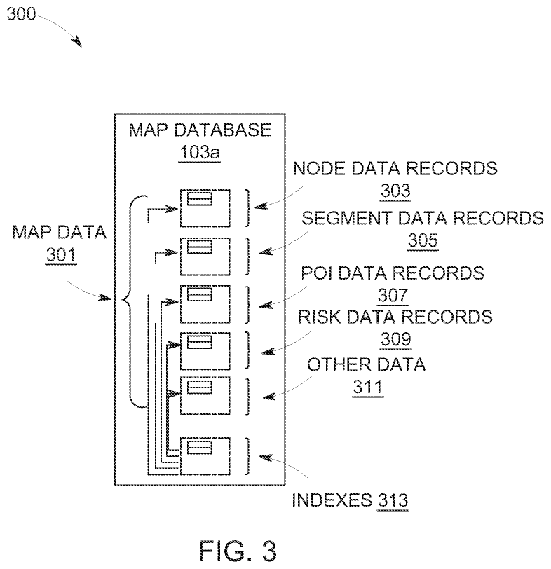

According to some example embodiments, the map database 103a may store a plurality of data records in the form of map data 301, as illustrated in FIG. 3. The map data 301 may further include data related to segment data records 305 such as node data 303, links or segments representing roads, streets, or paths, as may be used in calculating a route or recorded route information for determination of one or more personalized routes. The node data 303 may be end points (e.g., representing intersections) corresponding to the respective links or segments of road segment data. The road link data and the node data 3030 may represent a road network used by vehicles such as cars, trucks, buses, motorcycles, and/or other entities. Optionally, the map database 103a may contain path segment and node data records 303, such as shape points or other data that may represent pedestrian paths, links or areas in addition to or instead of the vehicle road record data, for example. The road/link segments and nodes can be associated with attributes, such as geographic coordinates, street names, address ranges, speed limits, turn restrictions at intersections, and other navigation related attributes, as well as POIs, such as fueling stations, hotels, restaurants, museums, stadiums, offices, auto repair shops, buildings, stores, parks, etc. The map database 103a may also store data about the POIs and their respective locations in the POI data records 307. The map database 103a may additionally store data about places, such as cities, towns, or other communities, and other geographic features such as bodies of water, mountain ranges, etc. Such place or feature data can be part of the POI data records 307 or can be associated with POIs or POI data records 307 (such as a data point used for displaying or representing a position of a city). In addition, the map database 103a may include other data 311, such as event data (e.g., traffic incidents, construction activities, scheduled events, unscheduled events, accidents, diversions etc.) associated with the POI data records or other records of the map database 103a associated with the mapping platform 103. Optionally, the map database 103a may contain path segment and node data records or other data that may represent pedestrian paths or areas in addition to or instead of the autonomous vehicle road record data. Additionally, the map data 301 may include a risk layer formed by risk data records 309, which comprises data related to vehicle characterization. Vehicles may be characterized into different risk categories, such as a high risk category, a medium risk category or a low risk category based on a risk factor associated with each vehicle. The risk factor may be determined based on machine learning algorithms run on real-time vehicle data, as obtained from on-road vehicles, and also from previous data about vehicles, stored in the map database 103a, using the methods and systems disclosed herein. Additionally, the machine learning algorithms use real-time vehicle communication data, such as V2V data, to determine vehicle characterization data and associated risk data, for the risk data records 309. Accordingly, the map database 103a may store the most updated risk data records 309, to identify risks posed by various vehicles on road, in a region, in a geography and the like. Apart from these various records stored in map data 301, the map database 103a may also store indexes 313 to enable fast retrieval of data from the map database 103a.

The map database 103a may be maintained by a content provider e.g., a map developer. By way of example, the map developer may collect geographic data to generate and enhance the map database 103a. There may be different ways used by the map developer to collect data. These ways may include obtaining data from other sources, such as municipalities or respective geographic authorities, or from a fleet of vehicles, such as probe vehicles or consumer vehicles and dedicated ground truth data collection vehicles. In addition, the map developer may employ field personnel to travel by vehicle along roads throughout the geographic region to observe features and/or record information about them, for example. Also, remote sensing, such as aerial or satellite photography, may be used to generate map geometries directly or through machine learning as described herein.

In some embodiments, the map database 103a may be a master map database stored in a format that facilitates updating, maintenance and development. For example, the master map database or data in the master map database may be in an Oracle spatial format or other spatial format, such as for development or production purposes. The Oracle spatial format or development/production database may be compiled into a delivery format, such as a geographic data files (GDF) format. The data in the production and/or delivery formats may be compiled or further compiled to form geographic database products or databases, which may be used in end user navigation devices or systems.

For example, geographic data may be compiled (such as into a platform specification format (PSF) format) to organize and/or configure the data for performing navigation-related functions and/or services, such as route calculation, route guidance, map display, speed calculation, distance and travel time functions, vehicle characterization and other functions, by a navigation device, such as by the system 101. The navigation-related functions may correspond to vehicle navigation, pedestrian navigation or other types of navigation. The compilation to produce the end user databases may be performed by a party or entity separate from the map developer. For example, a customer of the map developer, such as a navigation device developer or other end user device developer, may perform compilation on a received map database in a delivery format to produce one or more compiled navigation databases.

As mentioned above, the map database 103a may be a master geographic database, but in alternate embodiments, the map database 103a may be embodied as a client-side map database and may represent a compiled navigation database that may be used in or with end user equipment to provide navigation and/or map-related functions. For example, the map database 103a may be used with the system 101, which may be the user equipment to provide an end user with navigation features. In such a case, the map database 103a may be downloaded or stored locally (cached) on the user equipment.

The processing server 103b may comprise processing means, and communication means. For example, the processing means may comprise one or more processors configured to process requests received from the user equipment 105. The processing means may fetch map data from the map database 103a and transmit the same to the system 101 via OEM cloud 105 in a format suitable for use by the system 101. In another embodiment, the data collected from the vehicles is transmitted to the OEM cloud 105 for anonymization and then back to mapping platform 103 for further processing and aggregation. In one or more example embodiments, the mapping platform 103 may periodically communicate with the system 101 via the processing server 103b to update a local cache of the map data stored on the system 101. Accordingly, in some example embodiments, the map data may also be stored on the system 101 and may be updated based on periodic communication with the mapping platform 103.

In some example embodiments, the system 101 may be any form of user equipment or user accessible device such as a mobile phone, a smartphone, a portable computer, and the like that are portable in themselves or as a part of another portable/mobile object such as a vehicle. The user equipment may comprise a processor, a memory and a communication interface. The processor, the memory and the communication interface may be communicatively coupled to each other. In some example embodiments, the user equipment may be associated, coupled, or otherwise integrated with a vehicle of the user, such as an advanced driver assistance system (ADAS), a personal navigation device (PND), a portable navigation device, an infotainment system and/or other device that may be configured to provide route guidance and navigation related functions to the user. In such example embodiments, the user equipment may comprise processing means such as a central processing unit (CPU), storage means such as on-board read only memory (ROM) and random access memory (RAM), acoustic sensors such as a microphone array, position sensors such as a GPS sensor, gyroscope, a LIDAR sensor, a proximity sensor, motion sensors such as accelerometer, a display enabled user interface such as a touch screen display, and other components as may be required for specific functionalities of the user equipment. Additional, different, or fewer components may be provided. For example, the user equipment may be configured to execute and run mobile applications such as a messaging application, a browser application, a navigation application, and the like. In one embodiment, at least one user equipment may be directly coupled to the system 101 via the network 107. For example, the user equipment may be a dedicated vehicle (or a part thereof) for gathering data for development of the map data in the database 103a. In some example embodiments, at least one user equipment may be coupled to the system 101 via the OEM cloud 105 and the network 107. For example, the user equipment may be a consumer vehicle (or a part thereof) and may be a beneficiary of the services provided by the system 101. In some example embodiments, the user equipment may serve the dual purpose of a data gatherer and a beneficiary device. The user equipment may be configured to capture sensor data associated with a road which the user equipment may be traversing. The sensor data may for example pollution level in an area collected by pollution sensors in the vehicles. In another embodiment, the sensor data may be image data of road objects, road signs, or the surroundings (for example buildings). The sensor data may refer to sensor data collected from a sensor unit in the user equipment. In accordance with an embodiment, the sensor data may refer to the data captured by the vehicle using sensors, such as a camera, a LIDAR, a depth sensor or any imaging and visual perception system.

The network 107 may be wired, wireless, or any combination of wired and wireless communication networks, such as cellular, Wi-Fi, internet, local area networks, or the like. In one embodiment, the network 107 may include one or more networks such as a data network, a wireless network, a telephony network, or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks (for e.g. LTE-Advanced Pro), 5G or 6G New Radio networks, ITU-IMT 2020 networks, code division multiple access (CDMA), wideband code division multiple access (WCDMA), wireless fidelity (Wi-Fi), wireless LAN (WLAN), Bluetooth, Internet Protocol (IP) data casting, satellite, mobile ad-hoc network (MANET), and the like, or any combination thereof. In an embodiment the network 107 is coupled directly or indirectly to the system 101 via OEM cloud 105. In an example embodiment, the system 101 may be integrated in the user equipment. In an example, the mapping platform 103 may be integrated into a single platform to provide a suite of mapping and navigation related applications for OEM devices, such as the user devices and the system 101. The system 101 may be configured to communicate with the mapping platform 103 over the network 107. Thus, the mapping platform 103 may enable provision of cloud-based services for the system 101, such as, anonymization of observations in the OEM cloud 105 in batches or in real-time.

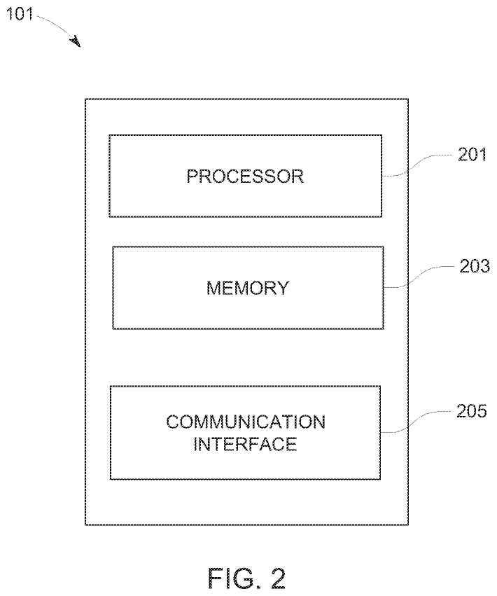

FIG. 2 illustrates a block diagram of the system 101 exemplarily illustrated in FIG. 1, for generating navigation information in a region, in accordance with an example embodiment. The system 101 may include a processing means such as at least one processor 201 (hereinafter, also referred to as “processor 201”), storage means such as at least one memory 203 (hereinafter, also referred to as “memory 203”), and a communication means such as at least one communication interface 205 (hereinafter, also referred to as “communication interface 205”). The processor 201 may retrieve computer program code instructions that may be stored in the memory 203 for execution of the computer program code instructions.

The processor 201 may be embodied in a number of different ways. For example, the processor 201 may be embodied as one or more of various hardware processing means such as a coprocessor, a microprocessor, a controller, a digital signal processor (DSP), a processing element with or without an accompanying DSP, or various other processing circuitry including integrated circuits such as, for example, an ASIC (application specific integrated circuit), an FPGA (field programmable gate array), a microcontroller unit (MCU), a hardware accelerator, a special-purpose computer chip, or the like. As such, in some embodiments, the processor 201 may include one or more processing cores configured to perform independently. A multi-core processor may enable multiprocessing within a single physical package. Additionally, or alternatively, the processor 201 may include one or more processors configured in tandem via the bus to enable independent execution of instructions, pipelining and/or multithreading.

In some embodiments, the processor 201 may be configured to provide Internet-of-Things (IoT) related capabilities to users of the system 101, where the users may be a traveler, a rider, a pedestrian, and the like. In some embodiments, the users may be or correspond to an autonomous or a semi-autonomous vehicle. The IoT related capabilities may in turn be used to provide smart navigation solutions by providing real time updates to the users to take pro-active decision on turn-maneuvers, lane changes, overtaking, merging and the like, big data analysis, and sensor-based data collection by using the cloud based mapping system for providing navigation recommendation services to the users. Additionally, or alternatively, the processor 201 may include a machine learning module, for configuring the system 101 to provide learning based capabilities for information processing. For example, the processor 201 may include a first machine learning model that may be used to obtain information associated with a vision based perception system, such as from one or more sensors, associated with the system 101, and use it in combination with other information to generate a local map associated with surroundings of the system 101. For example, when the system 101 is implemented in a vehicle, such as the ego vehicle, the processor 201 may be configured to receive the visual perception based information from one or more sensors of the ego vehicle and generate the local map of the surroundings of the ego vehicle, using the first machine learning model. In addition to the sensor data, the processor 201 may also be configured to use vehicle communication data associated with one or more vehicle in vicinity of the ego vehicle, for generating the local map for the system 101. The system 101 may be accessed using the communication interface 205. The communication interface 205 may provide an interface for accessing various features and data stored in the system 101.

Additionally, or alternatively, the processor 201 may include one or more processors capable of processing large volumes of workloads and operations to provide support for big data analysis. In an example embodiment, the processor 201 may be in communication with the memory 203 via a bus for passing information among components coupled to the system 101.

The memory 203 may be non-transitory and may include, for example, one or more volatile and/or non-volatile memories. In other words, for example, the memory 203 may be an electronic storage device (for example, a computer readable storage medium) comprising gates configured to store data (for example, bits) that may be retrievable by a machine (for example, a computing device like the processor 201). The memory 203 may be configured to store information, data, content, applications, instructions, or the like, for enabling the apparatus to carry out various functions in accordance with an example embodiment of the present invention. For example, the memory 203 may be configured to buffer input data for processing by the processor 201. As exemplarily illustrated in FIG. 2, the memory 203 may be configured to store instructions for execution by the processor 201. As such, whether configured by hardware or software methods, or by a combination thereof, the processor 201 may represent an entity (for example, physically embodied in circuitry) capable of performing operations according to an embodiment of the present invention while configured accordingly. Thus, for example, when the processor 201 is embodied as an ASIC, FPGA or the like, the processor 201 may be specifically configured hardware for conducting the operations described herein. Alternatively, as another example, when the processor 201 is embodied as an executor of software instructions, the instructions may specifically configure the processor 201 to perform the algorithms and/or operations described herein when the instructions are executed. However, in some cases, the processor 201 may be a processor specific device (for example, a mobile terminal or a fixed computing device) configured to employ an embodiment of the present invention by further configuration of the processor 201 by instructions for performing the algorithms and/or operations described herein. The processor 201 may include, among other things, a clock, an arithmetic logic unit (ALU) and logic gates configured to support operation of the processor 201.

The communication interface 205 may comprise input interface and output interface for supporting communications to and from the system 101 or any other component with which the system 101 may communicate. The communication interface 205 may be any means such as a device or circuitry embodied in either hardware or a combination of hardware and software that is configured to receive and/or transmit data to/from a communications device in communication with the system 101. In this regard, the communication interface 205 may include, for example, an antenna (or multiple antennae) and supporting hardware and/or software for enabling communications with a wireless communication network. Additionally, or alternatively, the communication interface 205 may include the circuitry for interacting with the antenna(s) to cause transmission of signals via the antenna(s) or to handle receipt of signals received via the antenna(s). In some environments, the communication interface 205 may alternatively or additionally support wired communication. As such, for example, the communication interface 205 may include a communication modem and/or other hardware and/or software for supporting communication via cable, digital subscriber line (DSL), universal serial bus (USB) or other mechanisms.

FIG. 3 illustrates a block diagram 300 of the map database 103a used to store data, such as sensor data for generating navigational information in a region, in accordance with an example embodiment. FIG. 3 is explained in conjunction with FIG. 1 and FIG. 2. With reference to FIG. 3, there are shown the node data records 303, the road segment or link data records 305, the POI data records 307, the risk data record 309, the other data records 311, and the indexes 313 stored in the map database 103a, as also discussed previously in conjunction with FIG. 1.

In one embodiment, the map database 103a may be configured to store, associate and/or link data such as, historical map data (e.g., parking data, traffic data, weather data, map feature data, risk data etc.) and specialized sensor data and map data generated according to the various embodiments described herein, and/or any other information used or generated by the mapping platform 103 with respect to providing map data updates. In one embodiment, the map database 103a may include map data 301 used for (or configured to be compiled to be used for) mapping and/or navigation-related services indicative of risk level information for characterization of vehicles, such as for route information, service information, estimated time of arrival information, location sharing information, speed sharing information, and/or geospatial information sharing, according to exemplary embodiments. The map data 301 may be collected through plurality of sources, such as sensor data from vehicles, roadside sensors, municipalities, third party sources, government agencies, health service providers and the like, and ingested into the map database 103a. Further, the data collected from these pluralities of sources may then be compiled into a suitable format and stored in the map database 103a. For example, the map database 103a may include node data records 303, road segment or link data records 305, POI data records 307, the risk data record 309, other data records 311, and indexes 313. More, fewer or different data records can be provided.

In one embodiment, these records store map data 301 and/or features used for generating map data for the geographic region under various contexts according to the embodiments described herein. In an embodiment, the map data 301 may also be referred to as map layer. For example, the features and/or contexts include, but are not limited to: (1) functional class of the link (e.g., principal arterial roadways, minor arterial roadways, collector roadways, local roadways, etc.); (2) POI density along a link (e.g., how many POIs are located along the link); (3) night life POI density along a link (e.g., how many POIs classified related to night life are along the link, such as restaurants, bars, clubs, etc.); (4) POI types along a link (e.g., what other types of POIs are located along the link); (5) population density along a link (e.g., the population of people living or working areas around the link); (6) road density along a link (e.g., how many roads are within a threshold distance of the link); (7) zoning (e.g., CBD, residential, etc.); (8) time epoch (e.g., segmentation by a defined period of time such as 15 mins, 1 hour, etc. periods of time); (9) weekday/weekend; (10) bi-directionality (e.g., whether traffic flows in two or multiple directions along the link); and (11) accessibility to public transit (e.g., proximity to subways, buses, transit stations, etc.).

In one embodiment, the other data records 311 may include cartographic (“carto”) data records, routing data, and maneuver data. One or more portions, components, areas, layers, features, text, and/or symbols of the POI or event data can be stored in, linked to, and/or associated with one or more of these data records. For example, one or more portions of the POI, event data, or recorded route information can be matched with respective map or geographic records via position or GPS data associations (such as using known or future map matching or geo-coding techniques), for example.

In one embodiment, the indexes 313 may improve the speed of data retrieval operations in the map database 103a. In one embodiment, the indexes 313 may be used to quickly locate data without having to search every row in the map database 103a every time it is accessed.

In exemplary embodiments, the road segment data records 305 are links or segments representing roads, streets, or paths, as can be used in the calculated route or recorded route information. The node data records 303 are end points corresponding to the respective links or segments of the road segment data records 305. For example, the nodes represent road intersections. The road segment data records 305 and the node data records 303 represent a road network, such as used by vehicles (like the user equipment 105), cars, and/or other entities. Alternatively, the map database 103a may comprise path segment and node data records or other data that represent pedestrian paths or areas in addition to or instead of the vehicle road record data, for example.

The road link and nodes can be associated with attributes, such as geographic coordinates, street names, address ranges, speed limits, turn restrictions at intersections, and other navigation related attributes, as well as POIs, such as traffic controls (e.g., stoplights, stop signs, crossings, etc.), gasoline stations, hotels, restaurants, museums, stadiums, offices, automobile dealerships, auto repair shops, buildings, stores, parks, etc. The map database 104 may include data about the POIs and their respective locations in the POI data records 307. The map database 104 can also include data about places, such as cities, towns, or other communities, and other geographic features, such as bodies of water, mountain ranges, etc. Such place or feature data can be part of the POI data records 307, can be associated with POIs or POI data records 307 (such as, a data point used for displaying or representing a position of a city).

In one embodiment, the risk data record 309 may include map associated with any data item associated with sensor data used by the mapping platform 103. The sensor data may include data from the vehicle visual sensors. In accordance with an embodiment, the sensor data may comprise location data, data associated with nearby vehicles of an ego vehicle, one or more road objects, road intersection, pedestrians, cyclists, signals or the like. In an embodiment, the sensor data may also include behavior of surrounding such as the behavior of vehicles on road, behavior of pedestrians on the roadside, behavior of other vehicles on or near the intersection. In accordance with an embodiment, the behavior may be associated with risk or dangerous situations on the road. The behavior may be associated with risky situations like “How to react in a situation where the vehicle coming from opposite direction suddenly changes the lane?” and “How to react in a situation when there is sudden decrease in speed of vehicle moving ahead of the vehicle”? And “How to react in a situation where pedestrians start crossing the road without waiting for any signal”? And “How to react in a situation when the vehicles on the road are over speeding”? In an embodiment, the risk data record may also be referred to as risk layer or traffic layer of the mapping platform 103.

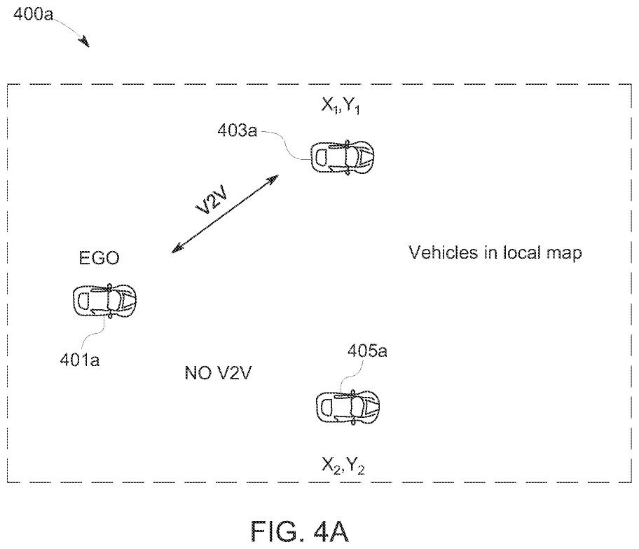

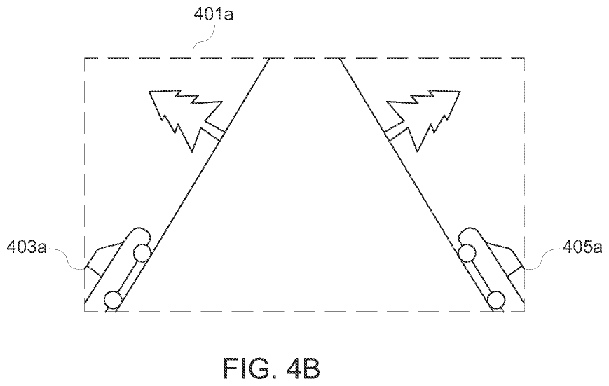

In an embodiment, the risk data record 309 may also include vehicle communication data, a detailed explanation of which is provided in conjunction with FIG. 4. In an embodiment, the risk data record 309 may further include data associated with risk factors associated with various vehicles. The risk factors may be associated with one or more predefined categories of vehicles, which may be risk categories, such as a high risk category, a medium risk category, and a low risk category. The type of category that a vehicle is characterized with indicates a level of risk that the vehicle poses to other vehicles in its vicinity. For example, a high risk category vehicle poses a high risk of mishappening to other vehicles in its vicinity, such as in the form of high collision possibility, vehicle swerving, vehicle breakdown, erratic driving and the like. Likewise, a medium risk vehicle poses a risk of mishappening that is neither very high, nor too low. The high or low degree may be determined based on probabilistic measures, such as high probability or low probability and the like. Similarly, a low risk vehicle poses minimum or very low risk of mishappening to other vehicles in its vicinity. One such vehicle may be the ego vehicle, equipped the system 101 to process the sensor data and vehicle communication data to generate navigation related information and to generate situational awareness for the ego vehicle.

The map database 103a can be maintained by the content provider in association with a map developer. The map developer can collect map data 301 to generate and enhance the map database 103a. There can be different ways used by the map developer to collect data. These ways can include obtaining data from other sources, such as municipalities or respective authorities. In addition, the map developer can employ field personnel to travel by vehicle along roads throughout the geographic region to observe features and/or record information about them, for example. Also, remote sensing, such as aerial or satellite photography, can be used.

The processes described herein for providing map data updates related to provision of navigation services may be advantageously implemented via software, hardware (e.g., general processor, Digital Signal Processing (DSP) chip, an Application Specific Integrated Circuit (ASIC), Field Programmable Gate Arrays (FPGAs), etc.), firmware or a combination thereof. Such exemplary hardware for performing the described functions will be described with associated block diagrams, as detailed in following description.

FIG. 4A illustrates an exemplary block diagram of a scenario for generating a local map of surroundings of a vehicle. As illustrated in the block diagram of FIG. 4, an ego vehicle 401a may be located in a region 400a, such as on a road or a highway, along with two other vehicles 403a and 405a in a vicinity of the ego vehicle 401a. The vicinity of the ego vehicle 401a may be described as an area bounded by a circle of a radius corresponding to a predetermined distance threshold. The predetermined distance threshold may be a configurable value, such as 50 m, 100 m, 200 m and the like. Further, the vehicles 403a and 405a may form a part of surroundings of the ego vehicle 401a. The surroundings of the ego vehicle 401a may also include other road objects apart from the vehicles 403a and 405a. For example, the surroundings of the ego vehicle 401a may include a road sign, a traffic cone, a guard rail, a construction road zone indicator (all of which are not shown in the figure) and the like. It may be understood by one of ordinary skill in the art that the number of surrounding vehicles shown in the FIG. 4A are two, only for exemplary purpose. In actual implementation, any reasonable number of vehicles may form a part of a road scene scenario for the ego vehicle, without deviating from the scope of the present disclosure.

As illustrated in FIG. 4A, the vehicle 403a may be able to communicate with the ego vehicle 401a over a wireless connection, such as for vehicle data communication or V2V communication. In V2V communication, the vehicles 401a and 403a may be able to communicate over a Dedicated Short Range Communications (DSRC) channel, for exchanging safety related information for vehicle communications. The safety related information may include such as speed data for one or more vehicles 403a, acceleration data for one or more vehicles 403a, heading data for one or more vehicles 403a and the like. The safety related information may also include driver and driving behavior related information for one or more vehicles 403a.

In some embodiments, the vehicle communication data, such as using a DSRC channel, is also obtained from one or more road objects apart from the one or more vehicle 403a, such as from road intersections, plurality of road objects discussed earlier and the like.

In some embodiments, the vehicle 405a does not have V2V capabilities and thus, is not able to exchange safety and/or other related information with the ego vehicle 401a.

However, apart from vehicle communication data, the ego vehicle 401a may also obtain sensor related data about the one or more vehicles 403a and/or 405a in its vicinity. The sensor may be a camera, or a visual perception system associated with the ego vehicle 401a. For example, FIG. 4B illustrates visual perception system 400b associated with the ego vehicle 401a, which shows the front camera view of the ego vehicle 401a, which captures vehicles 403a, 405a and other objects, such as trees in field of view of the camera.

In some embodiments, the sensor data may include first information associated with the one or more vehicles 403a and 405a, which may include one or more of make information, model information and identity information associated with the one or more vehicles 403a and 405a. For example, using the on-board camera of the ego vehicle 401a, the system 101 (which may be installed in the ego vehicle 401a) may determine that the vehicle 403a has a make X₁ and a model Y₁. Similarly, the system 101 may determine that the vehicle 405a has a make X₂ and a model Y₂. Thus, the system 101 would use sensor inputs into a program, such as a computer program comprising computer-executable instructions, that may be executed by the processor 201 and may be stored in the memory 203 of the system 101. The computer-executable instructions may then identify surrounding vehicles, such as vehicles 403a and 405a, and attribute safety characteristics to each one based on observed behaviors and vehicle integrity information as obtained using sensor data inputs and vehicle communication data. All this information may then be integrated to generate a local map of the surrounding vehicles. This local map may then be transmitted to the mapping platform 103.

In the mapping platform, the local map transmitted by the ego vehicle 401a may be used in a number of ways. The local map may be used to update map data 301, specifically the risk data records 309.

In some embodiments, a machine learning model stored in the mapping platform 103 is used to provide an output data based on processing of the local map. The output data may be used to provide navigation related information for safe navigation of the ego vehicle 401a. The output data may be in the form of vehicle characterization data. The vehicle characterization data may be used to characterize each of the vehicle 403a and 405a into predefined risk categories, as previously discussed. This may then further be used to generate navigation instructions for the ego vehicle 401. The navigation instructions may be provided by the system 101, which may be an autonomous driving system, and helps to perform path planning. The autonomous system will then have access to all vehicle actuators as well, to control the maneuvering of the ego vehicle 401a according to navigation instructions, in some embodiments.

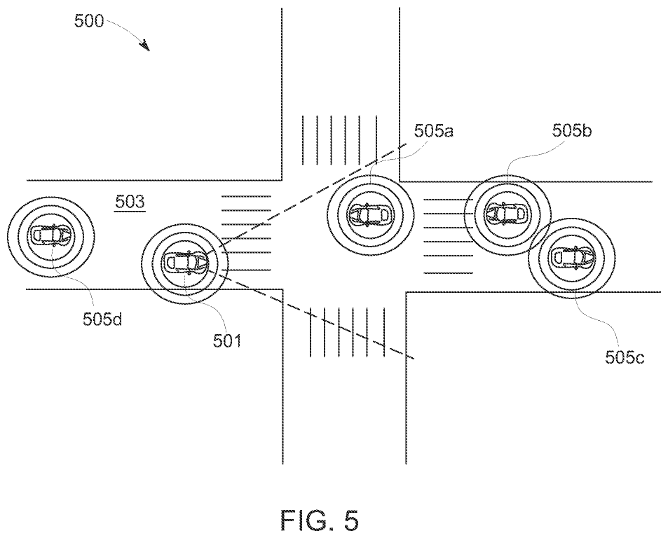

FIG. 5 illustrates a block diagram of another exemplary scenario 500 for generating navigation information in a region, in accordance with an example embodiment. According to one example embodiment, a vehicle 501 (such as including the system 101) and a plurality of other vehicles 505a, 505b, 505c and 505d may be traveling on a road 503. The road 503 may be part of a way leading the vehicle 501 and the plurality of vehicles 505a, 505b, 505c and 505d from a source location to a destination location.

The vehicle 501 may request for a route between two locations and the road 503 may be a part of the requested route. Similarly, the plurality of vehicles 505a, 505b, 505c and 505d may also be traversing the road 503 as the part of the route, but some vehicles in plurality of vehicles may traverse in opposite direction in which the vehicle 501 is travelling. In an embodiment, the vehicle 501 may be surrounded by one or more dangerous situations. In an embodiment, the dangerous situations may include risky and unexpected driving behavior of the vehicles on the road 503. For example, if the vehicle 505a is moving in a zig zag way and the driver of the vehicle 505a may not be in control, or the vehicle 505a is in wrong lane or the driver of the second vehicle is swerving. These situations may create risk for the vehicle 501, one or more other vehicles, such as the vehicle 505d on the road 503 and in surrounding of the vehicle 501. Therefore, the system 101 may be invoked to generate safety awareness instructions on the road 503. In order to resolve such situation, the system 101 may be configured to generate awareness instructions to the user of the vehicle. The awareness instructions may be generated based on sensor data and vehicle communication data and using machine learning algorithms to predict occurrence of risky situations. Such predictions are based on local map of surroundings of the vehicle 501, that may be generated using a first machine learning model and vehicle 501's visual perception data and a number of other conditions.

The other conditions may comprise such as a time of day, a day of a week, weather, and even the geo-location of the vehicle 501. For example, the vehicle 501 may be driven on the road 503 which falls in an area which is in a college town, at night, when there is a football game. Then the system 101 could draw on the fact that the vehicle 501 is in a college town and there is a football crowd out on the road 503 in order to make predictions about the behaviors of vehicles, such as 505a-505d, that it encounters. There may be a type of vehicle that is more likely to be owned by college students in the area. The system 101 may then generate navigation information, such as an alert instruction, for controlling the vehicle 501 just like a human driver becoming alert in such a scenario. Thus, the system 101 may offer advanced human cognitive system emulation capabilities, to help the vehicle 501 navigate safely in such a complex driving scenario. This enhances the overall safety provided by the system 101 foe navigation of the vehicle 501. you might be very cautious of that driver, and so should an autonomous system.

In some embodiments, the prediction of risky situation and generation of navigation information may be done based on processing of the local map of surroundings of the vehicle 501 by a second machine learning model, in the mapping platform 103.

The first machine learning model and the second machine learning model may comprise any known machine learning models in the art, such as deep learning models using neural networks, random forest algorithm based models, regression based models, classification based models like Support Vector Machine (SVM), convolutional neural networks (CNNs), Recurrent Neural Networks (RNNs) and the like. Each of these models may be pre-trained using a training dataset derived from data collected from a fleet of vehicles. The fleet of vehicles may include such as probe vehicles or consumer vehicles and dedicated ground truth data collection vehicles. The trained machine learning models may then be used to make accurate and up-to-date predictions for providing navigation information for the vehicle 501.

In some embodiments, the navigation information may comprise navigation instructions. For example, audio based navigation instructions, video based navigation instructions or access to vehicle 501's actuators for controlling the vehicle 501 (in case it is an autonomous or semi-autonomous vehicle), all comprise types of navigation information that may be generated using the system 101, when triggered, and the associated machine learning models.

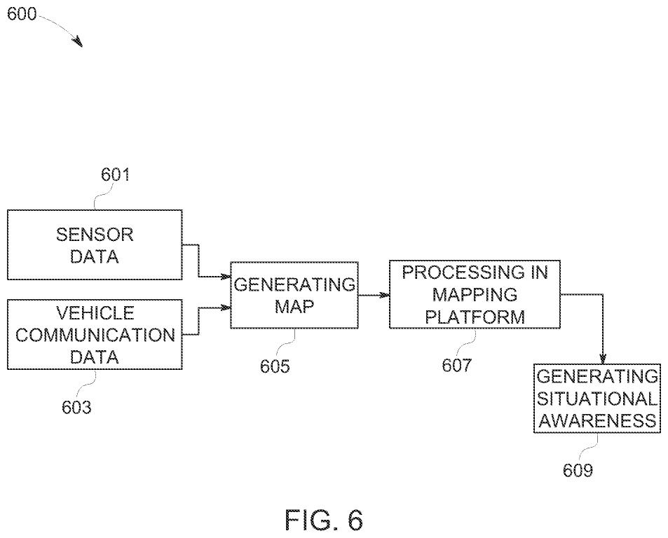

For example, the system 101 may be triggered when the vehicle 501 request the route from source to destination. In another embodiment, the system 101 may be triggered when the vehicle 501 encompasses dangerous situation in real time. In an embodiment, the vehicle 501 may be manual, autonomous or semi-autonomous vehicle. In order to solve this problem, the system 101 may further obtain sensor data and vehicle communication data, a detailed description of which is provided next with reference to FIG. 6.

FIG. 6 illustrates a block diagram 600 of a system (such as the system 101) for generating navigation information, in accordance with an example embodiment. At block 601, the system 101 may obtain sensor data associated with the vehicle 501. The system 101 may obtain sensor data of the vehicles in vicinity of the vehicle 501. For example, the vehicle 501 may obtain data associated with the vehicles 505a, 505b, 505c and plurality of road objects on the road 503. The plurality of objects may include signals, pedestrians, and cyclists on the road 503 (as explained previously in FIGS. 4A-4B).

At block 603, the system 101 may obtain vehicle communication data associated with the vehicle 501. In an embodiment, the system 101 may obtain the vehicle communication data by one or more of vehicle to vehicle (v2v) communication, vehicle to everything (v2x) communication, vehicle to pedestrian (v2p) communication. The vehicle communication data may include data of surrounding vehicle, or road objects. The vehicle communication data associated with the vehicle 501 may include vehicle speed, acceleration, heading direction of plurality of vehicles 505a, 505b, 505c and 505d on the road. In an embodiment, the v2v communication data may include data associated with vehicles within 300 meters radius of a vehicle. The vehicle communication data may also include vehicle control information such as transmission state, brake state, steering wheel angle, vehicle's path history and path prediction of vehicle on the road 503. Similarly, the system 101 may also obtain data associated with pedestrians or cyclists on the road 503. In an embodiment, the system 101 may also obtain more information associated with the surrounding from the map database 103a.

At block 605 the system 101 may further generate a local map associated with surrounding of the vehicle based on the obtained sensor data and vehicle communication data. The surrounding of the vehicle 501 may include the local map associated with spatial distribution of the plurality of vehicles 505a, 505b, 505c and 505d. The local map also includes exterior environment such as speed, brakes, signals and the like. In an embodiment, the generated map may be a virtual or a static map. Also, the local map may include an indication of the make and model information for each of the vehicles 505a, 505b, 505c, and 505d.

At block 607, the system 101 may further transmit the generated map to the map database 103a. As explained in FIG. 3, the map database 103a includes the risk layer including risk data records 309. The risk layer processes the generated map based on obtained sensor and vehicle communication data to determine the risk associated with driving of the vehicle 501. At block 609, the risk layer further generates navigation information as output data that may be provided to the user of the vehicle 503 based on the risk factor associated with the plurality of vehicles 505a-505d around the vehicle 501, and surrounding environment of the vehicle 501. The navigational information may include situational awareness or contextual awareness. For example, based on the sensor data and vehicle communication data associated with the vehicle 501, the system 101 determines that the vehicle 505a changed the lane. The system 101 may process the data in risk layer 309 and may generate an awareness notification of this kind of dangerous situation. The generation of the awareness notification may assist the user of the vehicle 501 to drive and react to the situation accordingly. In this way, the system 101 may assist the user to avoid accident like situation by providing spatial and situational awareness well in time, for accurate decision making.

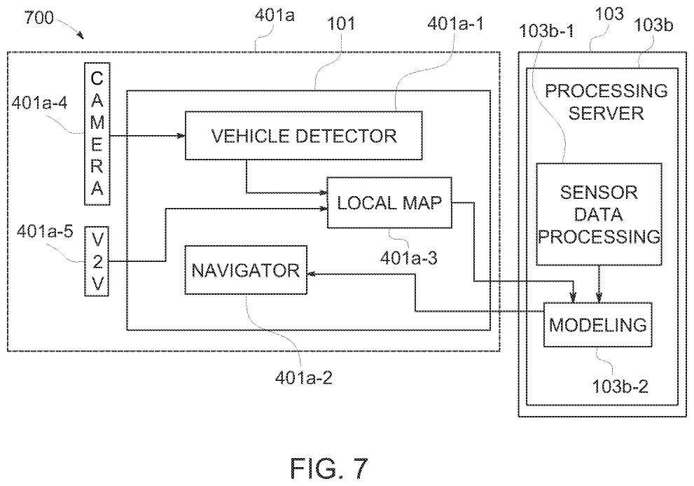

FIG. 7 illustrates another block diagram 700 of the system for generating navigation information, in accordance with another exemplary embodiment.

The block diagram 700 exemplarily illustrates how the system 101 may use the sensor data and vehicle communication data of the vehicle 401a, to provide navigation information. The navigation information may be in the form of vehicle characterization data.

As illustrated in the block diagram 700, in an embodiment, the vehicle 401a may be equipped with the sensor such as a camera 401a-4, and a vehicle communication unit, such as the V2V communication unit 401a-5. The vehicle communication unit could also be a V2X communication unit for receiving wireless communication data from a plurality of road objects, pedestrians, intersection points and the like in surrounding or vicinity of the vehicle 401a.

The camera 401a-4 may be configured to obtain sensor data, such as first information data for each of a plurality of vehicles in vicinity of the vehicle 401a. As previously discussed in conjunction with FIGS. 4A-4B, the camera 401a-4 may obtain first information indicating the make information, the model information and the identity information for the vehicles 403a and 405a, which are in the vicinity of the vehicle 401a. In some embodiments, the first information may be obtained by providing the sensor data from the camera 401a-4 to a vehicle detector unit 401a-1. The vehicle detector unit 401a-1 may be a part of visual perception system of the vehicle 401a and may store a first machine learning model, which may be a pre-trained deep learning model, as previously discussed. The first machine learning model may help to correctly determine the first information data for each of the one or more vehicles 403a and 405a based on previously stored data. In some embodiments, the vehicle detector unit 401a-1 also includes artificial intelligence capabilities.

Further, the V2V communication unit 401a-5 may be configured to obtain vehicle communication data, such as V2V data, from other vehicles equipped with V2V communication capabilities, and also from other entities such as road objects. For example, as illustrated in FIG. 4A, the vehicle 403a may be connected with vehicle 401a over a V2V communication channel, such as a DSRC channel. The vehicle communication data may include such as speed data, acceleration data, heading data, braking data, steering angle data and other safety data of the vehicle 403a.

The sensor data from the vehicle detector 401a-1, and the vehicle communication data from the V2V unit 401a-5 may then be fed to a local map generating unit 401a-3. The local map generation unit 401a-3 may then be configured to generate a local map associated with a surrounding of the vehicle 401a. The local map may be a static map representing distribution of the one or more vehicles, 403a and 405a, in the surrounding of the vehicle 401a and an indication of the first information associated with each of the one or more vehicles. The local map may be stored in the system 101 or may be transmitted to a remote server, such as the mapping platform 103, in a remote server or cloud based embodiment.

When the local map is transmitted to the mapping platform 103, which may be a remote server or a cloud computing based server, then the processing server 103b of the mapping platform 103 may perform further processing on the local map. To that end, the processing server 103b may include a sensor data processing module 103b-1 and a modeling unit 103b-2, to process the local map provided by the local map generating unit 401a-3. The modeling unit 103b-2 may include a second machine learning model to process the local map using deep learning and artificial intelligence capabilities. In some embodiments, the second machine learning model comprises a trained machine learning model, wherein the training is done based on actuarial data associated with a fleet of vehicles.

The modeling unit 103b-2 may generate an output data based on processing of the local map. In some embodiments, the output data comprises vehicle characterization data for each of the one or more vehicle 403a and 405a. The vehicle characterization data may comprise associating the vehicle with one or more predefined categories of vehicles, wherein the one or more predefined categories comprise at least one of a high risk vehicle, a low risk vehicle, a medium risk vehicle, or a combination thereof.

In some embodiments, the output data may be provided to a navigator unit 401a-2 in the system 101, for generating navigation information for the vehicle 401a. Thus, the system 100 may be able to provide warning about risk associated while driving of the vehicle 401a, such as collision risk, based on advanced artificial intelligence and machine learning capabilities, and also using more reliable data derived from vehicle sensor, historical vehicle data from a fleet of vehicles, and real-time vehicle communication data as well. This helps to improve overall accuracy and efficiency of the navigation system associate with vehicle 401a to provide safe navigation assistance in complex driving scenarios. Further, the distributed architecture illustrated in FIG. 7 also helps to reduce requirements of computational capacity on the system 101, as part of the processing may be done by the remote or cloud based mapping platform 103.

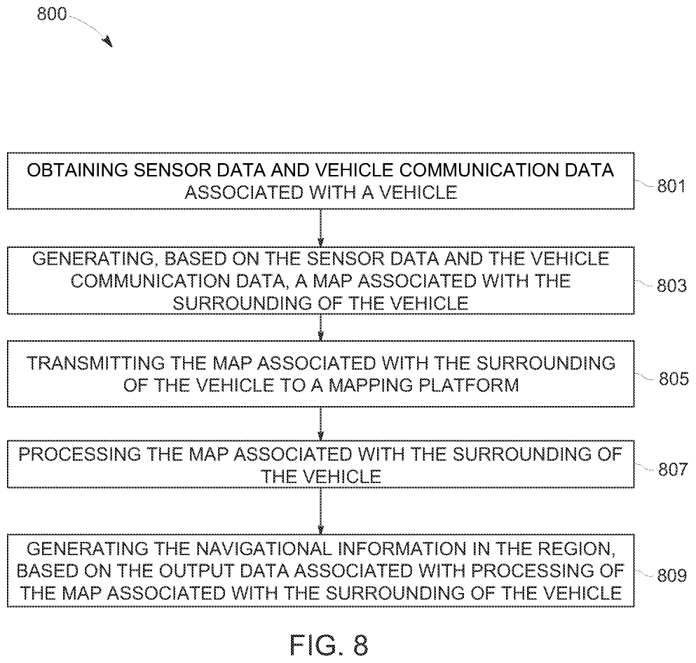

FIG. 8 illustrates a flow diagram of a method 800 for generating navigation information in a region, in accordance with an example embodiment. It will be understood that each block of the flow diagram of the method 800 may be implemented by various means, such as hardware, firmware, processor, circuitry, and/or other communication devices associated with execution of software including one or more computer program instructions. For example, one or more of the procedures described above may be embodied by computer program instructions. In this regard, the computer program instructions which embody the procedures described above may be stored by a memory 203 of the system 101, employing an embodiment of the present invention and executed by a processor 201. As will be appreciated, any such computer program instructions may be loaded onto a computer or other programmable apparatus (for example, hardware) to produce a machine, such that the resulting computer or other programmable apparatus implements the functions specified in the flow diagram blocks. These computer program instructions may also be stored in a computer-readable memory that may direct a computer or other programmable apparatus to function in a particular manner, such that the instructions stored in the computer-readable memory produce an article of manufacture the execution of which implements the function specified in the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flow diagram blocks.

Accordingly, blocks of the flow diagram support combinations of means for performing the specified functions and combinations of operations for performing the specified functions for performing the specified functions. It will also be understood that one or more blocks of the flow diagram, and combinations of blocks in the flow diagram, may be implemented by special purpose hardware-based computer systems which perform the specified functions, or combinations of special purpose hardware and computer instructions.

At step 801, the method 800 comprises obtaining sensor data and vehicle communication data associated with a vehicle. The sensor data may comprise data associated with one or more of a plurality of vehicles on a road, surrounding of the vehicle, one or more intersections, and plurality of road objects. The vehicle communication data may comprise speed data, acceleration data, and heading data associated with plurality of vehicles and plurality of road objects in vicinity of the vehicle, such as the ego vehicle 401a (also interchangeably referred to as the vehicle 401a).

At 803, the method 800 comprises generating, based on the sensor data and vehicle communication data, a local map associated with the surrounding of the vehicle. The local map may comprise spatial distribution of the plurality of vehicles in vicinity of the ego vehicle 401a and an indication of the first information associated with each of the plurality of vehicles (such as vehicles 403a and 405a in FIG. 4, or vehicles 505a-505d in vicinity of the vehicle 501 in FIG. 5). In some embodiments, the local map is generated using the first machine learning model as previously discussed.

At step 805, the method 800 may include, transmitting the map associated with the surrounding of the vehicle 401a to the mapping platform 403, wherein the mapping platform 103 comprises the map database 103b further comprising a map or risk layer including risk data records 309 (as shown in FIG. 3). The map layer may further comprise the risk layer or a traffic layer to determine traffic or risk in driving in a region where the data is obtained.

At step 807, the method 800 processing the local map associated with the surrounding of the vehicle in the mapping platform. The processing may be done based on a second machine learning model which may trained using previously stored data, such as data stored in the risk layer of the map database 103a. As a result of the processing, an output data may be provided by the mapping platform 103.

At step 809, the method 800 comprises generating the navigation information based on the output data associated with processing of the local map associated with the surrounding of the vehicle. The method 800 comprise may further generating an alert and safety message regarding dangerous situation to the user, so that the user may take appropriate decision while driving. The safety message may be in the form of an audio instruction such as “be careful passing” or “do not tailgate within 5 feet”, that may alert the user. As previously discussed, in some embodiments, the navigation information may be in the form of vehicle maneuvering data for controlling the vehicle 401a.

The method 800 may be implemented using corresponding circuitry. For example, the method 800 may be implemented by an apparatus or system comprising a processor, a memory, and a communication interface of the kind discussed in conjunction with FIG. 2.

In some example embodiments, a computer programmable product may be provided. The computer programmable product may comprise at least one non-transitory computer-readable storage medium having stored thereon computer-executable program code instructions that when executed by a computer, cause the computer to execute the method 800.

In an example embodiment, an apparatus for performing the method 800 of FIG. 8 above may comprise a processor (e.g., the processor 201) configured to perform some or each of the operations of the method of FIG. 8 described previously. The processor may, for example, be configured to perform the operations (801-809) by performing hardware implemented logical functions, executing stored instructions, or executing algorithms for performing each of the operations. Alternatively, the apparatus may comprise means for performing each of the operations described above. In this regard, according to an example embodiment, examples of means for performing operations (801-809) may comprise, for example, the processor 201 which may be implemented in the system 100 and/or a device or circuit for executing instructions or executing an algorithm for processing information as described above.

In this way, example embodiments of the invention result in generation navigation information in a region in an efficient, reliable and accurate manner. In many situations, the user may find it difficult to react in dangerous situations while driving. Therefore, the present disclosure provides the system 101 that generates safety message alerts and other navigational information to avoid such situations. Various embodiments may assist the user to take right decision to avoid such dangerous situations. In this disclosure the processing may be done by the mapping platform 103 (which may be in the form of a remote server or cloud based server) and it may enhance accuracy and speed of the decision taken by the user.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A method for generating navigation information in a region, the method comprising:
obtaining sensor data and vehicle communication data associated with a vehicle;
generating, based on the sensor data and the vehicle communication data, a local map associated with the surrounding of the vehicle, wherein the sensor data comprises a first information associated with one or more vehicles in vicinity of the vehicle, and wherein the first information is determined based on a first machine learning model;
transmitting the local map associated with the surrounding of the vehicle to a mapping platform;
processing, by a second machine learning model stored in the mapping platform, the local map associated with the surrounding of the vehicle, to provide an output data; and
generating the navigation information in the region, based on the output data associated with processing of the local map associated with the surrounding of the vehicle.

2. The method of claim 1, wherein the sensor data comprises data associated with one or more of the one or more vehicles in vicinity of the vehicle on a road, a surrounding of the vehicle, one or more intersections, and a plurality of road objects.

3. The method of claim 1, wherein the first information comprises information associated with at least one of a make information for each vehicle in the one or more vehicles, a model information for each vehicle in the one or more vehicles, or a combination thereof.

4. The method of claim 1, wherein the vehicle communication data comprises at least one of: speed data, acceleration data, and heading data; associated with at least one of the one or more vehicles in vicinity of the vehicle, and one or more road objects in vicinity of the vehicle.

5. The method of claim 1, wherein generating the navigation information in the region comprises generating information associated with situational awareness, and contextual awareness in the surrounding of the vehicle.

6. The method of claim 1, wherein providing the output data further comprises providing an alert notification to a user of the vehicle for providing navigation information in the region.

7. The method of claim 6, further comprising characterizing the vehicle based on the output data, wherein the characterizing comprises associating the vehicle with one or more predefined categories of vehicles, wherein the one or more predefined categories comprise at least one of a high risk vehicle, a low risk vehicle, a medium risk vehicle, or a combination thereof.

8. A system for generating navigation information in a region, the system comprising:
a memory configured to store computer executable instructions; and
one or more processors configured to execute the instructions to:
obtain sensor data and vehicle communication data associated with a vehicle;
generate, based on the sensor data and the vehicle communication data, a local map associated with the surrounding of the vehicle, wherein the sensor data comprises a first information associated with one or more vehicles in vicinity of the vehicle, and wherein the first information is determined based on a first machine learning model;
transmit the local map associated with the surrounding of the vehicle to a mapping platform;
process, by a second machine learning model stored in the mapping platform, the local map associated with the surrounding of the vehicle, to provide an output data; and
generating the navigation information in the region, based on the output data associated with processing of the local map associated with the surrounding of the vehicle.

9. The system of claim 8, wherein the sensor data comprises data associated with one or more of the one or more vehicles in vicinity of the vehicle on a road, a surrounding of the vehicle, one or more intersections, and a plurality of road objects.

10. The system of claim 8, wherein the first information comprises information associated with at least one of a make information for each vehicle in the one or more vehicles, a model information for each vehicle in the one or more vehicles, or a combination thereof.

11. The system of claim 8, wherein the vehicle communication data comprises at least one of: speed data, acceleration data, and heading data; associated with at least one of the one or more vehicles in vicinity of the vehicle, and one or more road objects in vicinity of the vehicle.

12. The system of claim 8, wherein generating the navigation information in the region further comprises generating information associated with situational awareness, and contextual awareness in the surrounding of the vehicle.

13. The system of claim 13, wherein to provide the output data, the one or more processors are further configured to provide an alert notification to a user of the vehicle for providing navigation information in the region.

14. The system of claim 8, wherein the one or more processors are further configured to execute the instructions to: characterize the vehicle based on the output data, wherein characterizing comprises associating the vehicle with one or more predefined categories of vehicles, wherein the one or more predefined categories comprise at least one of a high risk vehicle, a low risk vehicle, a medium risk vehicle, or a combination thereof.

15. A computer programmable product comprising a non-transitory computer readable medium having stored thereon computer executable instruction which when executed by one or more processors, cause the one or more processors to carry out operations for characterizing one or more vehicles, the operations comprising:
obtaining sensor data associated with the one or more vehicles, wherein the one or more vehicles are in vicinity of an ego vehicle;
determining, based on a first machine learning model, first information associated with each of the one or more vehicles in vicinity of the ego vehicle;
obtaining vehicle communication data associated with the one or more vehicles;
generating, based on the first information associated with each of the one or more vehicles and the vehicle communication data, a local map associated with a surrounding of the ego vehicle, wherein the local map comprises: a spatial distribution of the one or more vehicles in the surrounding of the ego vehicle; and an indication of the first information associated with each of the one or more vehicles;
transmitting, the local map associated with the surrounding of the ego vehicle, to a mapping platform;
processing, using a second machine learning model stored in the mapping platform, the local map associated with the surrounding of the ego vehicle; and
characterizing, based on the processing of the local map by the second machine learning model, each of the one or more vehicles to output a navigation information for the ego vehicle.

16. The computer program product of claim 15, wherein the navigation information for the ego vehicle comprises at least one of a navigation instruction for the ego vehicle, a risk factor associated each of the one or more vehicles in vicinity of the ego vehicle, or a combination thereof.

17. The computer program product of claim 15, wherein the sensor data comprises image data associated with each of the one or more vehicles and the first machine learning model comprises a trained vision based deep learning model, wherein the trained vision based deep learning model is trained using image data from a plurality of vehicles.

18. The computer program product of claim 15, wherein the first information associated with each of the one or more vehicles comprises at least one of a make information for each of the one or more vehicles, a model information for each of the one or more vehicles, or a combination thereof.

19. The computer program product of claim 15, wherein the vehicle communication data comprises at least one of speed data associated with each of the one or more vehicles, acceleration data associated with each of the one or more vehicles, and heading data associated with each of the one or more vehicles.

20. The computer program product of claim 15, wherein the second machine learning model comprises a trained machine learning model, wherein the training is done based on actuarial data associated with a fleet of vehicles.
